(19) United States
(12) Patent Application Publication
(10) Pub. No.: US 2015/0277675 A1
(43) Pub. Date: Oct. 1, 2015

(54) ANALYTICS THAT RECOMMEND WINDOWS ACTIONS IN A MULTI-WINDOWED OPERATOR ENVIRONMENT

(71) Applicant: CA, Inc., Islandia, NY (US)

(72) Inventors: Steve M. Firestone, San Diego, CA (US); Steven L. Greenspan, Scotch Plains, NJ (US); Judith M. Brown, Kanata (CA); Robert L. Biddle, Ottawa (CA)

(73) Assignee: CA, Inc., Islandia, NY (US)

(21) Appl. No.: 14/231,860

(22) Filed: Apr. 1, 2014

(51) Int. Cl. G06F 3/0482; G06F 3/0484; G06F 3/14

(52) U.S. Cl. CPC G06F 3/0482; G06F 3/1423; G06F 3/04842

(57) ABSTRACT

Adjusting a multi-windowed display includes determining a plurality of applications with which an operator is currently interacting, identifying a respective window in the multi-windowed display corresponding to each of the plurality of applications; and monitoring a respective information source associated with each of the plurality of applications. Adjusting the display also includes detecting a signature from one of the respective information source, the signature related to the associated application; and, based on the detected signature, adjusting how the window corresponding to the associated application is displayed within the multi-windowed display.

### BACKGROUND

The present disclosure relates to a windowed user interface, and more specifically, to controlling a multi-windowed user interface.

Operators using multiple monitors, or multiple windows on a single monitor, may typically arrange applications on the screen, or screens, in a personal but structured manner. For example, some operators may place all text chats on one monitor screen and place core applications on a different screen. Other operators may organize their screens differently. The challenge for many operators is being able to focus on their principal activities such as, for example, incident resolution while at the same time monitor various alert logs or alarm logs. Accordingly, the screens can become crowded with many windows.

In a crowded multi-windowed screen, some foreground windows can obscure information in other background windows. As a result, information relevant to the operator's tasks can be missed among the various windows on the various screens. Missing such information, even for a short period of time, can cause alarms and alerts to be overlooked. Unresponsiveness to alerts and alarms can cause issues to escalate quickly within large or critical information technology (IT) environments.

### BRIEF SUMMARY

According to one aspect of the present disclosure, a method for adjusting a multi-windowed display includes determining a plurality of applications with which an operator is currently interacting, identifying a respective window in the multi-windowed display corresponding to each of the plurality of applications; and monitoring a respective information source associated with each of the plurality of applications. The method also includes detecting a signature from one of the respective information source, the signature related to the associated application; and, based on the detected signature, adjusting how the window corresponding to the associated application is displayed within the multi-windowed display.

According to another aspect of the present disclosure, a system for adjusting a multi-windowed display includes a computer processor and a memory in communication with the computer processor storing instructions. The instructions, when executed by the computer processor implement: a windows manager module to determine a plurality of applications with which an operator is currently interacting and identify a respective window in the multi-windowed display corresponding to each of the plurality of applications; and a monitoring module to monitor a respective information source associated with each of the plurality of applications. The executed instructions also implement an analysis module to detect occurrence of a signature from one of the respective information sources, the signature related to the associated application; and the windows manager module to adjust, based on the detected signature, how the window corresponding to the associated application is displayed within the multi-windowed display.

According to another aspect of the present disclosure, a computer program product for adjusting a multi-windowed display includes a computer readable storage medium having computer readable program code embodied therewith. The computer readable program code includes; a) computer readable program code for determining a plurality of applications with which an operator is currently interacting; b) computer readable program code for identifying a respective window in the multi-windowed display corresponding to each of the plurality of applications; c) computer readable program code for monitoring a respective information source associated with each of the plurality of applications; d) computer readable code for detecting a signature from one of the respective information source, the signature related to the associated application; and e) computer readable program code for adjusting how the window corresponding to the associated application is displayed within the multi-windowed display, based on the detected signature.

### BRIEF DESCRIPTION OF THE DRAWINGS

Aspects of the present disclosure are illustrated by way of example and are not limited by the accompanying figures with like references indicating like elements.

FIG. 1 illustrates an example computing environment in which a multi-window control framework can be deployed in accordance with the principles of the present disclosure.

FIG. 2 is an example of a multi-window interface in accordance with the principles of the present disclosure.

FIG. 3 illustrates a flowchart of an example multi-window control process in accordance with the principles of the present disclosure.

FIG. 4 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or by combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Rash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable. RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CU, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

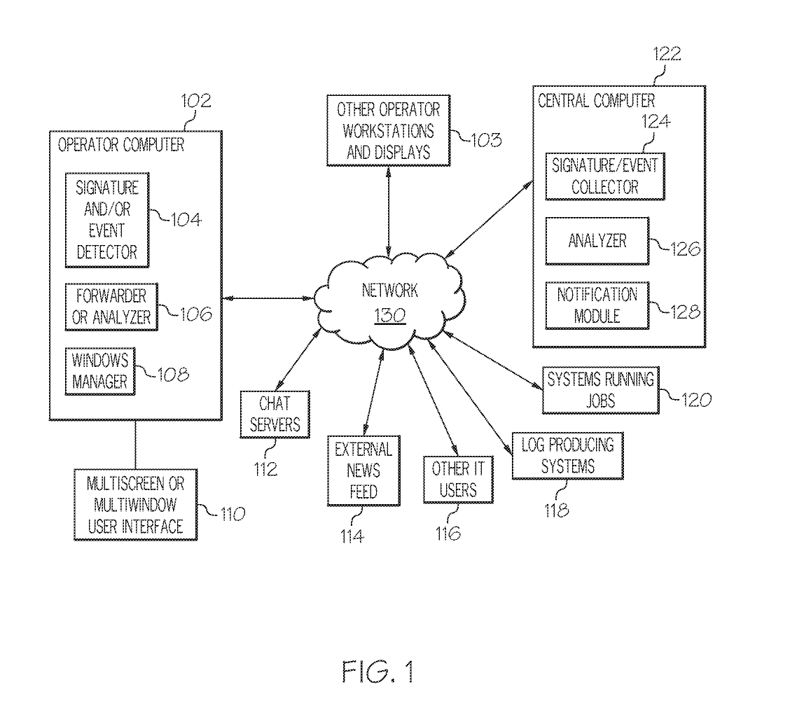

FIG. 1 illustrates an example computing environment in which a multi-window control framework can be deployed in accordance with the principles of the present disclosure. Within the environment of FIG. 1, an operator computer 102 can communicate through a network 130 with various other systems and users. For example, a central computer 122 may be present that has enterprise-level capabilities and resources to provide various applications and servers across an enterprise. Accordingly, the central computer 122 can be a plurality of distributed, individual systems although it is depicted as a single system 122 in FIG. 1. There may be a number of additional operator computers and displays 103 in addition to the operator computer 102 discussed in detail below.

The operator of the operator computer 102 can, for example, be responsible for various IT operation monitoring and support functions within the enterprise. As such, the operator may be involved with a number of chat sessions, or instant messaging sessions, with other IT users 116 utilizing one or more chat servers 112. The operator can subscribe to various news feeds 114 (e.g., stock market, weather, IT security organizations, geo-political stories, etc.) that could impact one or more resources or applications within the enterprise. Various systems 118 within the enterprise will produce “logs” which can be monitored by the operator. For example, web services or web applications can produce logs about their operational status, network operation monitoring software can produce different logs about the conditions of network resources, service-desk software can produce (and update) logs about open/completed items, operating systems on mission-critical machines can produce error logs or syslogs as a general course of operation, and security-related applications can produce logs about failed authentications or other similar issues. In addition to all of these items, the operator can initiate, or simply monitor, jobs running on other systems 120 or on the local computer 102. Status messages, alert messages, or alarm messages from any one of these various applications or systems may identify issues to which the operator is expected to respond or acknowledge.

One area of technology that has been developed to assist with handling data that can be generated by the multitude of systems within the environment of FIG. 1, can generally be referred to as signature detection, anomaly detection, or event detection. For each software application on a system, an associated signature detection module can be configured to “subscribe” to related, or relevant, information sources such as window event logs, web server logs, live application logs, network feeds, system metrics, change monitoring, message queues, files, or similar items of interest. The signature detection module receives messages, data, and other output from the various information sources and forwards them to an analysis module that evaluates the information to determine an “activity signature” which is based on what type of activity is occurring at each of the information sources.

The functionality to receive data from various information sources and analyze the data can be embodied in a distributed environment or on a local machine. The environment of FIG. 1 illustrates both configurations. For example, the operator computer 102 can include a signature and/or event detector that monitors various information sources and provides that data to an analyzer 106. Based on the data received from the signature detector 104, the analyzer 106 can then instruct a windows manager 108 to adjust a multi-window display of a user interface (UI) 110. The UI 110 can be a single monitor with multiple windows and desktops or can include multiple monitors wherein each monitor can have its own multi-window display. For example, the UI 110 can be a graphical user interface (GUI) with a mouse, cursor, keyboard, menus, windows, etc., the UI 110 can be a touch user interface, or the UI 110 can be a combination of these, and other, types of user interfaces.

Alternatively, in a distributed embodiment, the signature detection and analysis can involve the central computer 122. The signature detector 104 on the operator computer 102 would still monitor various information sources but a forwarding module 106 would forward data to a signature, or event, collection module 124 on the central computer 122. Analysis of collected signature information would be performed by an analyzer 126 and, based on the analysis, an appropriate notification message would be constructed by a notification module 128 and transmitted to the operator computer 102. The windows manager 108 could then adjust the UI 110 based on the notification message.

One of ordinary skill will recognize that either of the above-described embodiments could be implemented without departing from the scope of the present disclosure. However, in the description below, the functionality of detecting signatures or events, analyzing that information, and adjusting windows of a UI accordingly are all described as residing on the operator computer 102. Describing the functionality in this manner is not intended to limit aspects of the present disclosure but is merely intended to provide a particular example environment in which to illuminate the inventive aspects of the present disclosure.

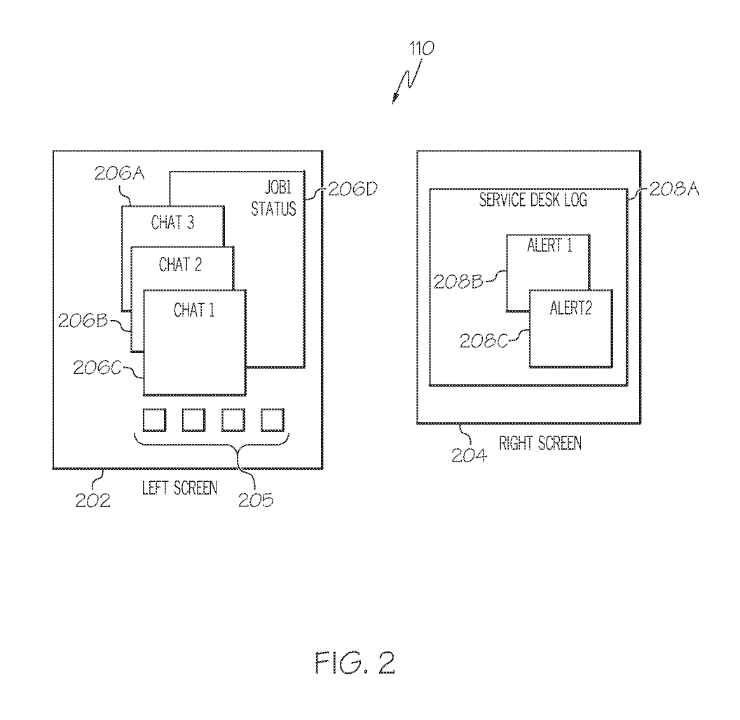

FIG. 2 is an example of a multi-window interface in accordance with the principles of the present disclosure. As shown in the left screen 202 of AG. 2, an operator can have multiple chat windows 206A, 2063, 206C open at once in order to, for example, provide software support to other users in real time. While at the same time a window 206D could be open that monitors the status of a currently running job on a remote computer, or the local computer. The contents of the window 206D could inform the operator of the progress of the running job or inform the operator of an error or problems with the job.

A right screen 204 may also have the attention of the operator and provide a log window 208A that, for example, shows the status of tickets or open items in a service-desk environment. Alert or alarm windows 208B, 2080 can also be visible on the right screen 204 and relate to various applications that the operator is monitoring. For example, various servers, hardware and other applications can be monitored within an IT environments and this monitoring software can generate alarms and alerts windows 208B, 208C which the operator can then respond to.

As shown in AG. 2, the various windows of the multi-windowed environment can be placed on different screens (202, 204) and within those screens they can overlap one another so that some, if not all, of a background window can be obscured by another window that is in the foreground. Because an operator cannot focus on all areas of the screens 202, 204 at once and because some of the windows may be obscured by other windows, the placement of the windows can cause some information to be missed or easily overlooked.

In some enterprise environments, it is not unusual for an operator to potentially have 20 or 30 simultaneous instant messaging sessions occurring at once. Accordingly, a number of these sessions could be iconified and re-opened as the operator interacts with different ones of the sessions. Four such iconified windows 205 are shown in AG. 2, Each of the iconified windows 205 represent a messaging session with which the operator is currently “interacting” but may not be actively interacting with (e.g., typing in input) and, thus, can be considered “dosed” messaging session which the operator can select and re-open.

In certain embodiments in accordance with the present disclosure, as described above, the information sources which can be associated with an application can widely vary. In particular, an information source can be separate from the window (e.g., 206A-206D) that corresponds to a particular application in the multi-window interface 110. In other words, the activity signature is something other than determining how the user is interacting with a particular window. For example, detecting whether or not a user has clicked a mouse on a particular window or dragged a window to a location are general functions of a user interface to control the appearance of a window. Furthermore, the system resources (e.g., amount of memory, CPU load, etc.) a particular window is using on a system can automatically effect an appearance of that window. In contrast, in accordance with the present disclosure, an activity signature from an associated information source that is separate from an application's corresponding window can be utilized in determining how to adjust a multi-windowed display.

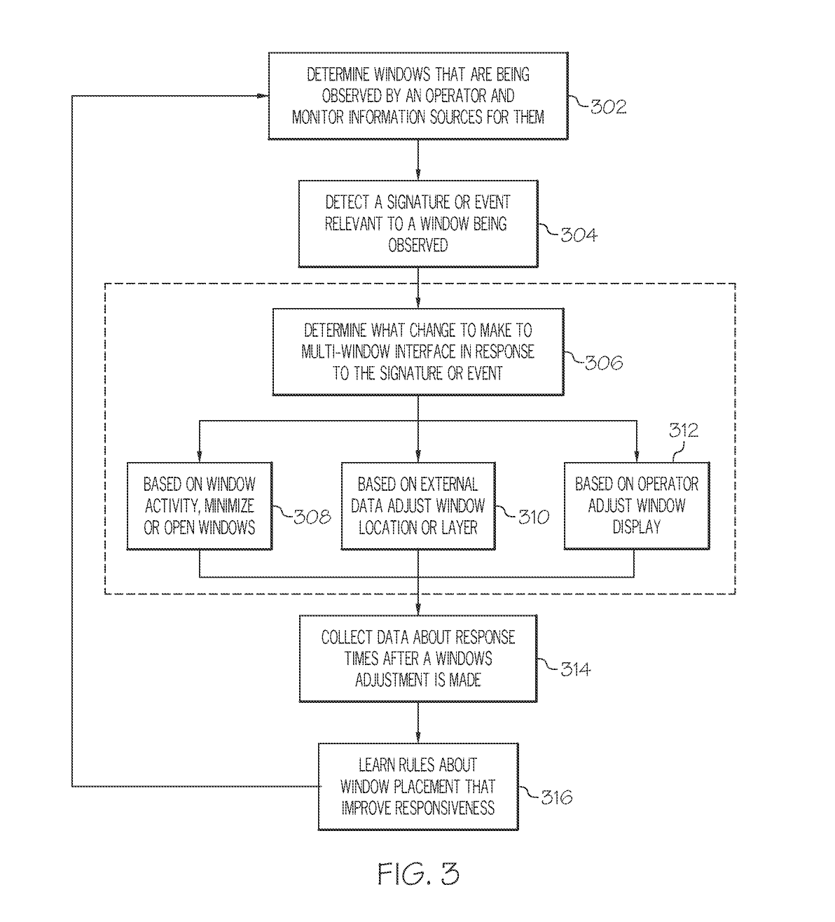

FIG. 3 illustrates a flowchart of an example multi-window control process in accordance with the principles of the present disclosure. This control process can be implemented for an operator computer 102 of an operator who is monitoring a variety of information sources that can produce a multi-windowed UI display similar to that of FIG. 2.

In step 302, a determination is made as to what windows an operator has open or is actively observing. This determination can, for example, be made by a portion of a windows manager 108 on the operator computer 102. As shown in FIG. 2, some of these windows may be in the foreground and some may be more in the background and some may even be iconified. Each window is associated with some type of application such as a chat window, an application log, an application status window, an alert window etc. Thus, the determination of what windows are being observed is, in essence, a determination of some of the local or remote applications with which the operator is currently interacting or is interested in, which could be determined directly (via interaction) or indirectly (via automated detection techniques such as, for example, eye-tracking). Thus, the operator may be passively “interacting” with, or “observing”, an application when the application is associated with a window that is presently a part of the multi-windowed display even if that window is minimized or the operator is not actively using that window for input.

Accordingly, step 302 includes monitoring those applications as information sources. Based on the monitoring of these applications, a signature or event relevant to one of the applications (or windows) can be detected in step 304. Rather than monitoring applications for which the operator does not have a currently-opened window, monitoring and signature detection can be limited to only those applications currently being observed by the operator. As discussed below, a window can be minimized to reduce display clutter but still be monitored so that it can return to the display if certain conditions are met. However, when an operator stops using an application altogether, then monitoring that application is no longer relevant and will not resume until the application is once again opened by the operator. For example, when an operator has been monitoring a log file (e.g., web server log) and the operator closes that window so that it is removed from the display, then that application is no longer monitored for events or signatures.

Monitoring information sources is not necessarily limited to monitoring just the applications themselves. For example, a particular news feed or some external source of information (separate from the application itself) could produce information relevant to the application. Thus, if a window is open for that application, then the relevant news feed can be monitored.

When an activity signature or event is detected that is related to an application, it can be analyzed, in step 306, to determine what change to make to the multi-window user interface.

For example, the determination in 306 may be that no activity has occurred in a particular window for a predetermined amount of time (e.g., 30 minutes). In response, the windows manager can be instructed, in step 308, to minimize that window. If the determination in step 306 reveals that no activity has occurred in any window of a display in a predetermined amount of time such that all the windows have been minimized, then that display can be powered-off. The predetermined amount of time before minimizing a window or powering off a display can vary based on the time of day. For example, that predetermined amount of time can be shortened during periods of the day where peak energy usage for the enterprise occurs.

Even though the windows are minimized, their associated applications can continue to be monitored as information sources. When activity resumes from any of those applications, then the display can be powered back on or a minimized window can be un-minimized. The un-minimized window can be brought to the foreground, its window placement can be changed, or even the screen on which it is displayed can be changed.

The determination in step 306 could also relate to an external news feed or other external source of information relevant to an application associated with one of the windows. Thus, instead of the application itself generating a signature or event, the external source of information provides a signature or event that is relevant to that application. Part of the configuration of monitoring an information source can include associating a news feed (or similar source) with a particular application and identifying keywords, or metrics, that are particularly relevant for the application. If those key words, or metrics, are detected in a monitored news feed, then the location or layer of the appropriate window can be adjusted by the window manager, in step 310.

For example, nearby weather events or disasters can initiate backup procedures to ensure data integrity. Alternatively, an operator could rely on that information to redirect resources and, thus, the news feed information would be relevant to a network operations monitoring application. Keywords related to stock market information, economic news, government reports and similar data could all be determined in step 306 to recommend a change in the way the various windows are displayed to the operator. For example, based on the news feed information, a window can be brought to the foreground and an alert message explaining why can be displayed. In addition to keywords, metrics can be defined which trigger a display adjustment in step 310 as well. For example, if a commodity prices changes more than a particular percentage, or the Dow average changes more than a particular percentage, then that is an event or signature that can be used to adjust the display in step 310.

The determination in step 306 may relate to changes in operator identity. For example, operators may have their own individual preferences about how to arrange and organize windows of a multi-window display. Certain operators may prefer windows for one type of application (e.g., chat windows) to all appear on the left display (or right display) or they may prefer that certain windows are in the foreground at the expense of other windows. Accordingly, if event activity within the various applications generating the multiple windows does not indicate otherwise, the windows can be displayed according to the personal preferences of a particular operator. These personal preferences can be stored so that they can be retrieved at a later time.

Thus, the determination in step 306 may reveal that according to a work schedule, or calendar, that a shift change has occurred such that a different operator is now responsible for the multi-window display 110 of the operator computer 102. The personal preferences of the new operator can be retrieved and used, in step 312, to adjust how the windows are displayed.

Even if there is no shift change, situations can occur in which responsibility for a particular window, or screen of windows, is re-assigned from one operator to another. Thus, if the determination in step 306 relates to a window or screen being re-assigned to a different operator, then in step 312, the window or screen can be displayed in accordance with that operator's personal preferences. Furthermore, re-assignment of a window can automatically result in the closing of that window or some recommendation for the new operator. For example, the window may relate to a help-desk session in which all of the events or issues have been resolved. Rather than clutter the new operator's display with such a window, the detection of re-assignment can automatically close that window or recommend to the new operator that the window can be closed.

In the above discussion, the example multi-window/multi-display user interface has been described within the context of a single operator utilizing the user interface. However, many network operating centers can include multiple operator stations that display the same information on multiple operator workstations. Thus, a monitoring window for a particular application or particular system may be open on different display screens belonging to different operators. One operator may be considered to be a primary responsible party for interacting with that monitoring window, but other operators may also be responsible as well. Re-assignment of windows between different operators is contemplated as well in step 306. The signature event in step 304 can be a determination that an operator is focused on a particular problem for an extended period of time and may not be interacting with other windows on a regular basis. Those other “neglected” windows, however, may also be on display on some other operator's screen and they can be adjusted in step 306 to draw attention. If some other operator does not already have one of the “neglected” windows in their screen, then that window can be pushed to their workstation and opened. Various criteria could be used to select the operator to whom the window is pushed such as, for example, who has the least amount of windows open, who most recently interacted with that subject matter within that window, or every operator on a list of responsible parties for the subject matter of that window.

The determination in step 306 (and the specific examples of steps 308, 310, and 312) provides a hierarchy of different rules that can apply to how a window is displayed in the multi-windowed UI. Application of these rules could include a) bringing a window to the foreground based on the detected signature or event, b) minimizing or un-minimizing a window, c) changing the location of a window on a screen, d) changing the size of a window on a screen, e) closing a window, or f) changing the display screen for a window. One of ordinary skill will recognize that there are other ways to adjust how a window can be displayed. For example, the color of a window (or just portions of the window) can change; also, the shading and color intensity of a window can be manipulated to draw an operator's attention to a desired portion; and animation is an effective technique for drawing attention on an, otherwise, static page. For example, jiggling a window can quickly draw an operator's attention to that window.

Once an adjustment is made to a multi-windowed display, an operator response typically occurs. If the determination in step 306 is simply to bring a window to the foreground because an event was detected from the application associated with that window, an operator will typically bring mouse or keyboard focus to that window even if no other explicit response is elicited. In other instances, the operator response will be more detailed and can involve closing windows or supplying input, etc. Thus, in step 314, data can usually be collected about operator response times that occur after a windows adjustment is made.

Based on the response times, autonomic learning of how the display of a window affects response times can occur, in step 316. For example, the data collected in step 314 can relate to average response times for an operator, what type of display adjustment occurred, and what was a response time after a particular adjustment. Accordingly, the autonomic learning can determine that a window display on the left screen rather than the right screen generally elicits a faster operator response. The autonomic learning could determine that windows near the bottom of a display, regardless of which display, are responded to faster than windows near the top. Thus, the autonomic learning process of step 316 can determine rules about screen placement, location placement, window size, and other window attributes which tend to reduce an operators response time after an adjustment to a multi-windowed display is made. Thus, in step 306, when a determination is made to re-open a window, bring a window to the foreground, or re-locate a window, the rules of 316 can be used to determine how that window can be displayed in the multi-windowed display.

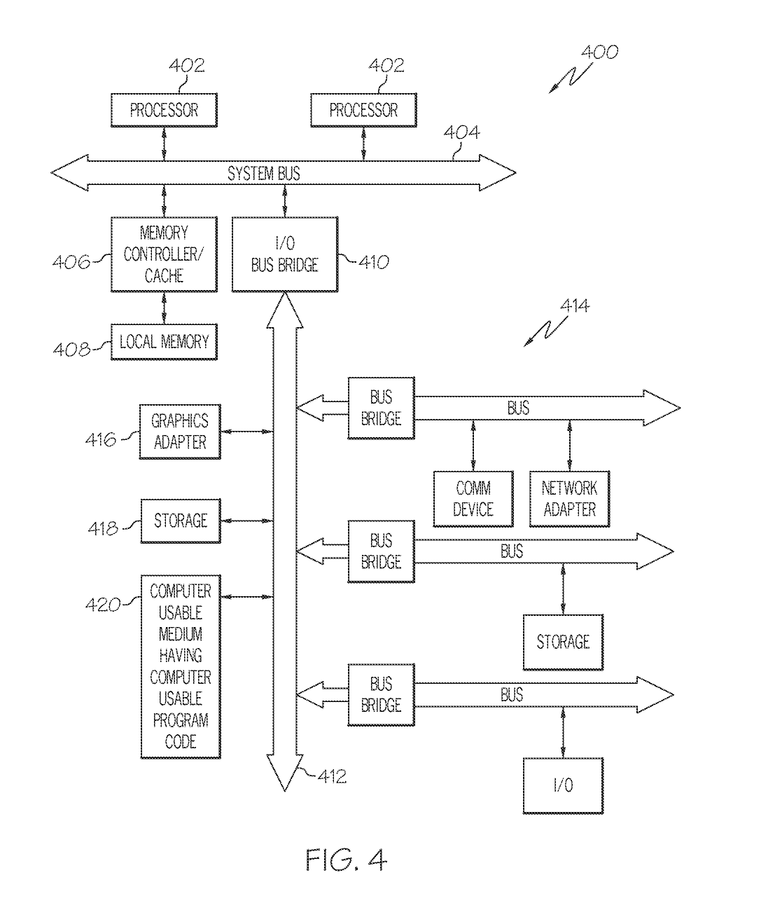

Referring to FIG. 4, a block diagram of a data processing system is depicted in accordance with the present disclosure. A data processing system 400, such as may be utilized to implement the hardware platform 102 or aspects thereof, e.g., as set out in greater detail in FIG. 1-FIG. 3, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interlace to an I/O bus 412. The I/O bus may be utilized to support one or more buses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 3.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application; and to enable others of ordinary skill in the art to understand the disclosure with various modifications as are suited to the particular use contemplated.

1. A computer-implemented method for adjusting a multi-windowed display, comprising:
determining, by a computer, a plurality of applications with which an operator is interacting;
identifying, by the computer, a respective window in the multi-windowed display corresponding to each of the plurality of applications;
monitoring, by the computer, a respective information source associated with each of the plurality of applications,
wherein the respective information source associated with each of the plurality of applications is separate from its corresponding window;
detecting, by the computer, an activity signature from one of the respective information sources, the activity signature related to the associated application; and
based on the detected activity signature, adjusting, by the computer, how the window corresponding to the associated application is displayed within the multi-windowed display.

2. The method of claim 1, wherein the respective information source comprises a news feed separate from the associated application.

3. The method of claim 1, comprising:
determining, by the computer, that the operator has ceased interacting with a particular one of the plurality of applications; and
stopping monitoring of the respective information source associated with that particular one application.

4. The method of claim 1, wherein the activity signature comprises an indication that no activity has occurred in the associated application for a predetermined period of time.

5. The method of claim 1, wherein the activity signature comprises an indication that an identity of the operator has changed.

6. The method of claim 5, comprising:
determining, by the computer, the identity of the operator;
retrieving, by the computer, a set of display preferences associated with the operator; and
adjusting, by the computer, the multi-windowed display in conformance with the set of display preferences.

7. The method of claim 1, wherein detecting the activity signature, comprises:
detecting, by the computer, that a particular window of the plurality of windows is re-assigned to a different operator.

8. The method of claim 1, wherein detecting the activity signature, comprises:
detecting, by the computer, that the operator is focused on one of the windows of the multi-windowed display and not on other windows of the multi-windowed display.

9. The method of claim 8, comprising:
re-assigning, by the computer, one of the other windows of the multi-window display to a workstation associated with a second operator.

10. A system for adjusting a multi-windowed display, comprising:
a computer processor;
a memory in communication with the computer processor storing instructions that when executed by the computer processor implement:
a windows manager module to determine a plurality of applications with which an operator is interacting and identify a respective window in the multi-windowed display corresponding to each of the plurality of applications;
a monitoring module to monitor a respective information source associated with each of the plurality of applications,
wherein the respective information source associated with each of the plurality of applications is separate from its corresponding window;
an analysis module to detect occurrence of an activity signature from one of the respective information sources, the activity signature related to the associated application; and
the windows manager module to adjust, based on the detected activity signature, how the window corresponding to the associated application is displayed within the multi-windowed display.

11. The system of claim 10, wherein the respective information source comprises a news feed separate from the associated application.

12. The system of claim 10,
wherein the windows manager module determines that the operator has ceased interacting with a particular one of the plurality of applications; and
wherein the monitoring module stops monitoring of the respective information source associated with that particular one application.

13. The system of claim 10, wherein the activity signature comprises an indication that no activity has occurred in the associated application for a predetermined period of time.

14. The system of claim 10, wherein the activity signature comprises an indication that an identity of the operator has changed.

15. The system of claim 14, comprising:
a detection module to determine the identity of the operator;
a set of display preferences associated with the operator, stored in the memory; and
wherein the windows manager module adjusts the multi-windowed display in conformance with the set of display preferences.

16. The system of claim 10, comprising:
a detection module to determine that a particular window of the plurality of windows is re-assigned to a different operator.

17. The system of claim 10, comprising;
a detection module to detect that the operator is focused on one of the windows of the multi-windowed display and not on other windows of the multi-windowed display.

18. The system of claim 17, comprising:
a re-assignment module to re-assign one of the other windows of the multi-window display to a workstation associated with a second operator.

19. A computer program product for adjusting a multi-windowed display, comprising:
a computer readable storage medium having computer readable program code embodied therewith, the computer readable program code comprising:
computer readable program code for determining a plurality of applications with which an operator is interacting;
computer readable program code for identifying a respective window in the multi-windowed display corresponding to each of the plurality of applications;
computer readable program code for monitoring a respective information source associated with each of the plurality of applications,
wherein the respective information source associated with each of the plurality of applications is separate from its corresponding window;
computer readable code for detecting an activity signature from one of the respective information sources, the activity signature related to the associated application; and
computer readable program code for adjusting how the window corresponding to the associated application is displayed within the multi-windowed display, based on the detected activity signature.
